(19) United States
(12) Patent Application Publication
(10) Pub. No.: US 2012/0061046 A1
(43) Pub. Date: Mar. 15, 2012

(54) INTERLOCKING ROOF MOUNTED HEAT-TRANSFER PANELS

(76) Inventors: Brett Goodrich, Murray, UT (US); Dennis N. Duce, Cottonwood Heights, UT (US)

(21) Appl. No.: 12/883,076

(22) Filed: Sep. 15, 2010

(51) Int. Cl. F24J 2/00; B23P 17/04; E04D 13/18

(52) U.S. Cl. 165/47; 52/173.1; 29/428

(57) ABSTRACT

A method is disclosed for installing heat transfer panels (typically of metal) on a roof. Panels are applied to the roof such that the panels have an interlocking relationship at interlocking interfaces between adjacent panels. An energy conducting element is laid among the panels such that the energy conducting element extends along the interlocking interfaces such that of the energy conducting element emits heat in all directions, preferably by contact 42 heat exchange panels. A roofing material is then applied over the panels and energy conducting element. The panels each have a first interlocking member positioned along one first lateral side and a second interlocking member positioned along a second lateral side. The second interlocking member is sized to receive the first interlocking member of an adjacent panel and a portion of the energy conducting element. Arcuate channels may be formed in the panels to receive a portion of the energy conducting element extending between adjacent interlocking interfaces.

### BACKGROUND

1. Field of the Invention

This invention relates to apparatus and methods for roofing, and more particularly for underlayment for melting snow and collecting solar energy using roof mounted structures.

2. The Background Art

During the winter, snow and ice accumulate on a roof covering a structure such as a dwelling or business space. Heat from the structure below rises and melts some of the snow and ice immediately above the structure. However, peripheral portions of the roof, especially the eaves, do not receive as much heat and may remain at subfreezing temperatures. Accordingly, water running off the heated portion may refreeze onto the peripheral portions resulting in an “ice dam” that can cause damage due to water backup and refreezing, snow and ice may also result in excess loading of the roof.

Some systems have been devised to prevent formation of ice dams. For example, a heating wire may be arranged on top of shingles above the eaves of a structure to melt snow. In a similar manner, a tube for carrying heated water may also be arranged above the eaves of a structure. These systems are somewhat ineffective in that they only heat a localized area of the roof. They rely on water melting and running down to melt other ice, but it usually runs underneath with slow and small melting effect. Moreover, they require installation after shingles or some other roofing material is applied, which can compromise the weatherproofing properties of the roofing material.

A metal slide plate may be placed on top of the roofing material to decrease gripping of snow. Some metal plates along the eaves of the house may improve distribution of heat. However, not only does heat rise away from wire sand plates, the plate captures moisture between itself and the roofing material which can result in decay of underlying sheathing. Others systems install a heating element before a roofing material is applied. However, these systems are suitable for use with a limited number of roofing materials in order to avoid puncturing the heating element during installation of the roofing material.

In view of the foregoing it would be an advancement in the art to provide a robust roof mounted heat emitting and collecting system that was simple to install using standard roofing materials and standard roofing installation methods.

### BRIEF SUMMARY OF THE INVENTION

The invention has been developed in response to the present state of the art and, in particular, in response to the problems and needs in the art that have not yet been fully solved by currently available apparatus and methods. The features and advantages of the invention will become more fully apparent from the following description and appended claims, or may be learned by practice of the invention as set forth hereinafter.

Consistent with the foregoing, a method for installing a heat transfer system on a roof includes applying panels to the roof such that the panels have an interlocking relationship at interlocking interfaces between adjacent panels. A heating element is laid among the panels such that the heating element extends along the interlocking interfaces such that an upper surface of the heating element does not protrude above the panels. A roofing material is then applied over the panels and heating element. The roofing material may be at least one of asphalt shingles, metal panels, tar and gravel, shakes, clay tiles, and concrete tiles.

In some embodiments, the panels each include first and second lateral sides, a first interlocking member positioned along the first lateral side, and a second interlocking member positioned along the second lateral side, the second interlocking member sized to receive the first interlocking member of an adjacent panel and a portion of the heating element.

In some embodiments, the panels are applied to a base layer having channels formed therein such that the second interlocking member is positioned within the channel. The second interlocking member may extend downward from the panel such that it is positionable within the channel.

In some embodiments, the panels each define at least one arcuate channel extending between the first and second lateral sides. In such embodiments, laying the heating element comprises laying the heating element within both the second interlocking elements and arcuate channels of the panels.

### BRIEF DESCRIPTION OF THE DRAWINGS

In order that the advantages of the invention will be readily understood, a more particular description of the invention briefly described above will be rendered by reference to specific embodiments illustrated in the appended drawings. Understanding that these drawings depict only typical embodiments of the invention and are not therefore to be considered limiting of its scope, the invention will be described and explained with additional specificity and detail through use of the accompanying drawings, in which:

FIG. 1A is an isometric view of a heat transfer panel in accordance with an embodiment of the present invention;

FIG. 1B is an end elevation view of assembled heat transfer panels in accordance with an embodiment of the present invention;

FIG. 1C is a top plan view of assembled heat transfer panels in accordance with an embodiment of the present invention;

FIG. 2A is a top plan view of heat transfer panels assembled according to an alternative embodiment of the present invention;

FIG. 2B is an end elevation view of heat transfer panels assembled as shown in FIG. 2A;

FIG. 3A is a top plan view of heat transfer panels assembled according to another alternative embodiment of the present invention;

FIG. 3B is an end elevation view of heat transfer panels assembled as shown in FIG. 3A;

FIG. 4A is an isometric view of one embodiment of a base layer having grooves formed therein for receiving heat transfer panels in accordance with an embodiment of the present invention;

FIG. 4B is a top plan view of heat transfer panels assembled on a base layer as shown in FIG. 4A in accordance with an embodiment of the present invention;

FIG. 4C is an end elevation view of heat transfer panels assembled as shown in FIG. 4B;

FIG. 5A is an isometric view of an alternative embodiment of a heat transfer panel in accordance with an embodiment of the present invention;

FIG. 5B is a top plan view of assembled heat transfer panels as shown in FIG. 5A in accordance with an embodiment of the present invention;

FIG. 5C is an end elevation view of assembled heat transfer panels as shown in FIG. 5B; and

FIG. 6 is a method for assembling heat transfer panels on a roof in accordance with an embodiment of the present invention.

### DETAILED DESCRIPTION OF THE PREFERRED EMBODIMENTS

It will be readily understood that the components of the present invention, as generally described and illustrated in the Figures herein, could be arranged and designed in a wide variety of different configurations. Thus, the following more detailed description of the embodiments of the invention, as represented in the Figures, is not intended to limit the scope of the invention, as claimed, but is merely representative of certain examples of presently contemplated embodiments in accordance with the invention. The presently described embodiments will be best understood by reference to the drawings, wherein like parts are designated by like numerals throughout.

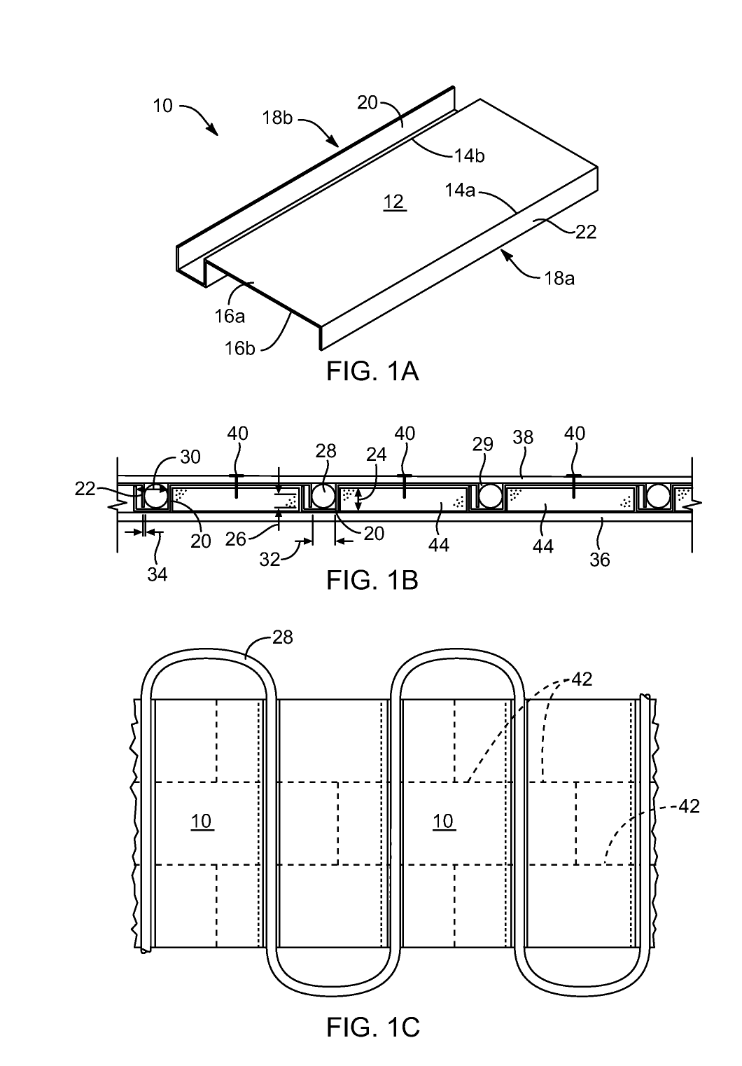

Referring to FIG. 1A, a panel 10 suitable for use in accordance with an embodiment of the present invention may include a planar portion 12 having first and second lateral sides 14a, 14b and upper and lower surfaces 16a, 16b. The panel 10 typically may include a heat conducting material in order to do at least one of collecting heat from solar radiation and spreading heat from a heating element. In some embodiments the panel 10 is formed of a metal such as aluminum or steel. However, any other heat structural materials having suitable heat conduction may also be used to similar effect. The material of the panels may itself be a specially engineered heat conducting material or edge 14a.

A first interlocking member 18a extends along the first lateral side 14a or edge 14b and a second interlocking member extends 18b along the second lateral side 14b or edge 14b. The second interlocking member 18b is sized to receive the first interlocking member 18a of an adjacent panel 10 when the panel 10 is installed on a roof. In the illustrated embodiment, the second interlocking member 18b is a channel 20 and the first interlocking member 18a is a downwardly depending flange 22. The illustrated channel 20 has a substantially rectangular cross section, but other cross-sectional shapes such as polygonal, curved, semicircular and the like are also suitable. The channel 20 and flange 22 may comprise portions of the panel 10 bent into the illustrated configuration. For example, the panel 10 may include sheet metal stamped into the illustrate configuration and cut to size. Alternatively, the channel 20 and flange 22 may be secured to the planar portion 12 by means of fasteners, welding, an adhesive, or other suitable fastening means.

Referring to FIGS. 1B and 1C, the channel 20 has a depth 24 below the upper surface 16a of the panel 10. The depth 24 is preferably equal to a height 26 of a energy conducting element 28 positioned within the channel 20 following installation of the panel 10. If less, contact is still made all around the conducting element 28. If less, potting may assure contact. In fact, potting is always a way to improve thermal contact on any side. Even well-fitted conducting elements 28 may have potting 29. The region 29 may best be filled with a solid, cured polymer, putty, or the like, but may simply be filled with air. The channel 20 has a width 30 equal to or greater than a combined width 32 of the energy conducting element 28 and a thickness 34 of the flange 22. The energy conducting element 28 may be embodied as a polymer or metallic tube for conducting heated fluid or an electrically conductive heating element for converting electric current into heat in order to melt snow, ice, or both.

In some embodiments, the energy conducting element 28 carries fluid for receiving heat from the roof. For example, the energy conducting element 28 may be used to collect solar energy in order to generate electricity, heat water, or heat an interior space. In some embodiments, fluid may be pumped through the energy conducting element 28 to collect heat energy in order to reduce the temperature of the roof and reduce a cooling load on the structure covered by the roof.

In use, a plurality of panels 10 may be placed on a roof, such as by placing the panels 10 on a base layer 36 designed to provide vertical support from below and possibly anchoring for fasteners holding roofing surface materials above. The base layer may include wooden sheathing, rigid foam, or other material capable of supporting the panels against damage. In some applications, the base layer 36 is sheathing or insulation such as is placed on a vertical wall or a roof of a building. The energy conducting element 28 is then laid within the second interlocking member 18b, such as within the channel 20 in the illustrated embodiment.

Arcuate portions of the energy conducting element 28 extending from the ends of the channel 20 may connect portions of the energy conducting element 28 within the channel 20. Thus, the energy conducting element 28 forms an undulating shape across the surface of the base layer 36. As noted above, the depth 24 of the channel 20 is preferably less than or equal to the height 26 of the energy conducting element 28, potted, or both. Thus, an upper surface of the energy conducting element 28 does not usually extend below the upper surface 16a of the planar portion 12 following placement in the channel 20 unless potted to assure contact thereabove.

Prior to installation of the panels 10, a roofing sealer such as tar paper, polymer membrane, or the like may be applied. Following installation of the panels 10, one or more layers of final roofing material 38 may be applied to the panels 10. For example, the roofing material 38 may include shingles or metal panels secured to the panels by means of fasteners 40 such as nails. The roofing material 38 may include any roofing material known in the art, such as asphalt shingles, metal panels, tar and gravel, shakes, clay tiles, concrete tiles, polymeric tiles and the like

Referring specifically to FIG. 1C, it is readily apparent that the above described apparatus and method provide an easily performed method of installing an energy conducting element 28 below a layer of roofing material 38 that does not require pre-measured or pre-engineered components. Panels 10, when having a standardized size, can be applied in whatever number necessary to cover a given area. An arbitrary length of energy conducting element 28 may then be installed.

The resulting structure is suitable for receiving any type of roofing material, including those that require the use of fasteners that penetrate the panel 10, such as nails and screws commonly used to install shingles and metal roofing panels. Most roofing materials 38 are supplied as discrete roofing elements 42 covering a small area of the roof, such as shingles, shakes, or tiles. The location of the energy conducting element 28 where discrete roofing element 42 is to be secured can be readily ascertained. An installer can clearly see the panels 10 and conducting elements 28 as each discrete roofing element 42 is placed. The installer can thereby avoid the potential damage of driving a fastener 40 into the energy conducting element 28.

In some embodiments, the area of the upper surface 16a of the panels 10 may be greater than the area of the discrete roofing elements secured thereto. For example, the area of the upper surface 16a of the panels 10 may be between 2 and 50 times the area of the discrete roofing elements secured thereto.

Referring again to FIG. 1B, in some embodiments, the panels 10 may include insulating material 44 secured adjacent the lower surface 16b of the panel 10. In this manner, installation of the panels 10 may simultaneously install a layer of insulation 44 over the base layer 36. The insulating material 44 may include a rigid material such as a rigid wood, chipboard, plywood, waferboard, foam, or the like, but may also include a non-rigid material whenever the panel 10 provides sufficient structural strength and stiffness to prevent crushing of the insulating material 44. For example, the insulating material may include fiberglass or other batting materials.

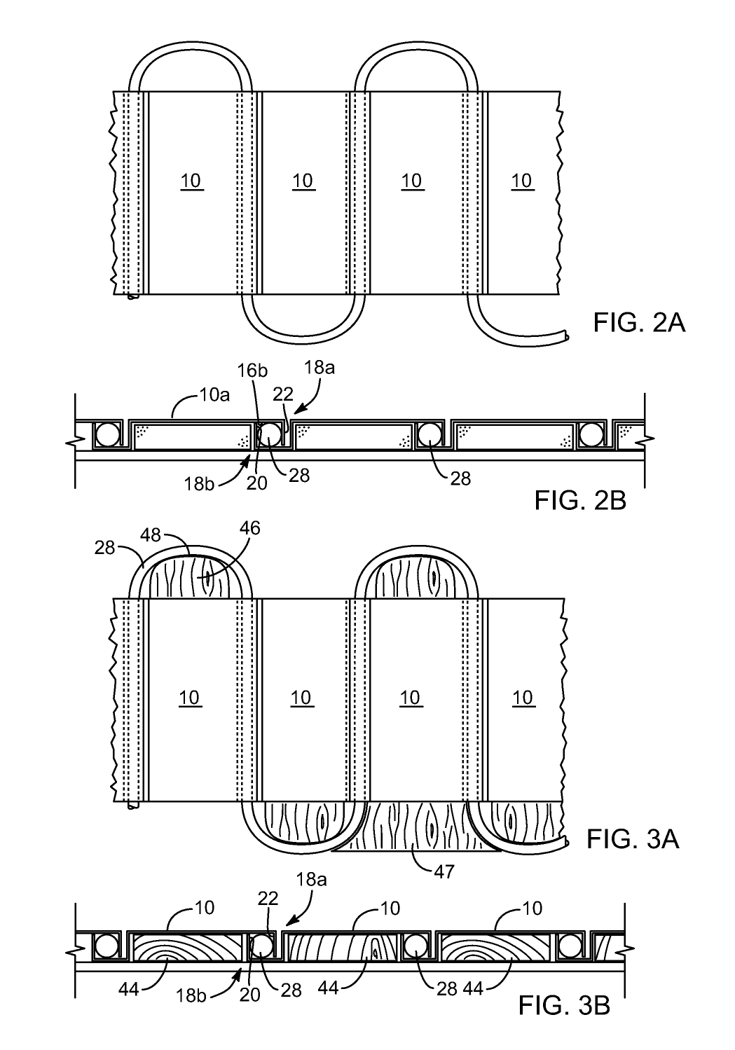

Referring to FIGS. 2A and 2B, in some embodiments, the energy conducting element 28 may be captured between a first panel 10a and an adjacent second panel 10b. For example, the energy conducting element 28 may be placed within an enclosed channel defined by the flange 22 of the first panel 10a, the lower surface 16b of the first panel 10a and the channel 20. The energy conducting element 28 may be laid into the open channel rather than threaded through the enclosed channel. Assembly of panels 10 is simultaneous with laying of the conducting element 28 when placed in the channel 20 of the second panel 10b prior to placement of the first panel 10a.

Referring to FIGS. 3A and 3B, in some embodiments, the insulating material may include an end portion 46 having an arcuate surface 48 to guide bending of the energy conducting element 28. The end portion 46 may advantageously prevent kinking of the energy conducting element 28 during installation. Optionally an opposite end portion 47 may have a complementary shape and provide more complete support for the final roofing material. In the embodiment of FIGS. 3A and 3B, the insulating material 44 may advantageously be or include a rigid foam or other rigid insulating material. In the insulating material 44 may also be, or be replaced by, a structural material such as wood.

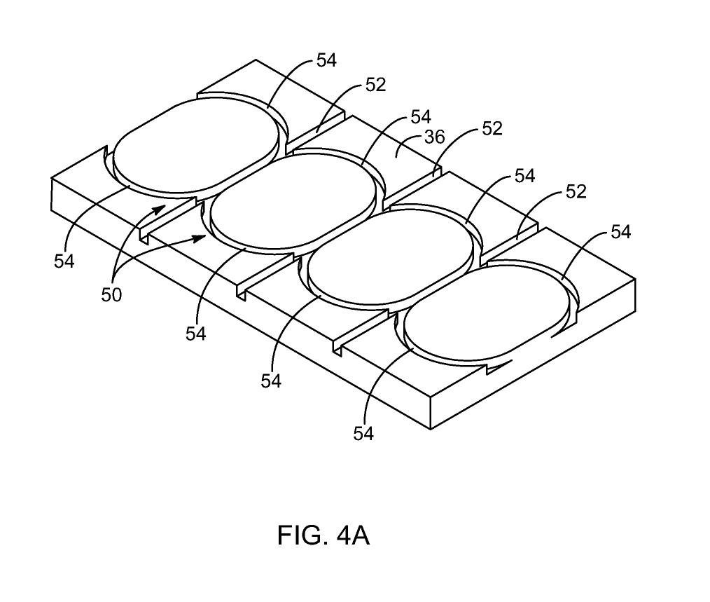

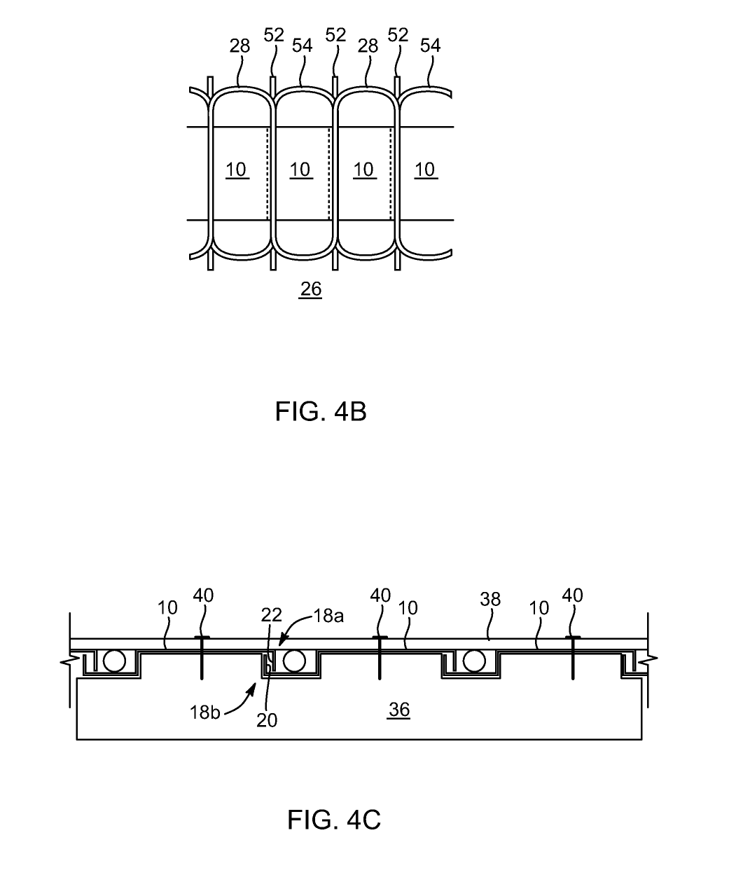

Referring to FIG. 4A, in some embodiments, the base layer 36 has grooves 50 formed therein to receive one or more of the first interlocking members 18a and arcuate portions of the energy conducting element 28. For example, the grooves 50 may include parallel straight grooves 52 spaced apart across the base layer 36 and arcuate grooves 54 extending between adjacent straight grooves 52. In the illustrated embodiment, two arcuate grooves 54 having opposite concavity extend between adjacent straight grooves 52 proximate the top and bottom ends thereof. In an alternative embodiment, the concavity of the arcuate grooves 54 alternates between each set of adjacent straight grooves 52 to form an undulating pattern.

Formation of two arcuate grooves 54 of opposing concavity proximate the top and bottom of each set of adjacent straight grooves 52 may advantageously enable greater freedom in placing the heating element within the grooves 52, 54 during installation. Also, the aspect ratio of width-to-length of the repeating oval pattern may be designed at virtually any suitable number. For example, length may depend on how much of the roof surface or eave is to be heated. The width may depend on how much heat density is desired Likewise, the base layer may be made in sections having one or many ovals formed therein.

Referring to FIGS. 4B and 4C, in use, panels 10 may be placed in an interlocking relationship such as described hereinabove with respect to FIGS. 1A through 3B having the second interlocking member 18b, such as the channel 20, positioned within one of the straight grooves 52 of the base layer 36 illustrated in FIG. 4A. The energy conducting element 28 may then be placed in an undulating pattern having portions thereof placed within the second interlocking member 18b, such as the channel 20 as described hereinabove. Arcuate portions of the heating and conducting element 28 extending between adjacent second interlocking members 18b may be positioned within the arcuate grooves 52. A layer of roofing material 38 may then be applied to the panels 10 and base layer 36 as described hereinabove.

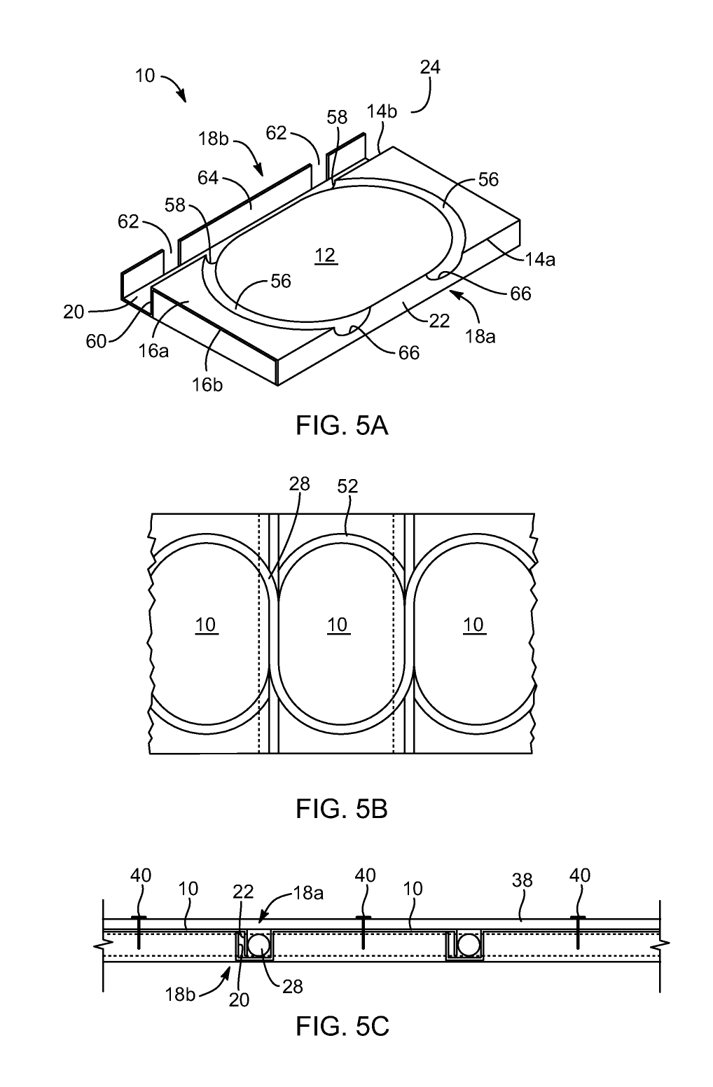

Referring to FIG. 5A, in some embodiments, the panel 10 further includes one or more arcuate channels 56. In some embodiments, some panels 10 include arcuate channels 56 having a first concavity and other panels 10 include channels 56 having an opposite concavity, or are positioned such that the channel 56 thereof is of opposite concavity. Such panels of each type can be placed alternatingly on the base layer 36 to form an undulating path, including the arcuate channels 56 and the channels 20 of the panels.

In the illustrated embodiment, each channel 20 includes two arcuate portions 56 or arcuate channels 56 having opposing concavity. The channel 20 may include an opening 58 formed in a wall 60 of the channel 20 secured to the lateral side 14b of the planar portion 12. An opening 58 may be located adjacent each arcuate channel 56 to enable an energy conducting element 28 within the arcuate channel 56 to extend into the straight portion of the channel 20.

The channel 20 may include additional openings 62 for each channel 56 formed in a wall 64 of the channel 20 opposing the wall 60. The flange 22 of each panel 10 may include openings 66 positioned adjacent each arcuate channel 56 to enable a energy conducting element 28 positioned within the arcuate channel 56 to extend into the channel 20 of an adjacent panel 10. In the illustrated embodiment, the openings 66 are placed in a position corresponding to the openings 62 such that an energy conducting element 28 may extend through both openings 62, 66 without excessive bending or risk of shearing.

In embodiments where the panel 10 is formed by stamping, or otherwise forming, sheet metal, the openings 58, 62, 66 may be cut prior to stamping. The one or more arcuate channels 56 may be formed during the same stamping operation that forms the main portion of the channel 20 and flange 22, or they may be formed in a separate operation.

Referring to FIGS. 5B and 5C, in use, the panels 10 of FIG. 5A are placed in an interlocking relationship as described hereinabove with respect to the other embodiments disclosed. The first interlocking member 18a, such as the flange 22, of each panel 10, placed in the second interlocking member 18b, such as the channel 20, of an adjacent panel 10 having the openings 66 of the flange 22 approximately aligned with the openings 62 in the wall 64 of the channel 20. An energy conducting element 28 is then placed in the channels 20, 5b of each panel 10 to form an undulating pattern.

The energy conducting element 28 may be placed over each panel 10 such that it extends through a portion of each channel 20, through the opening 58 in the wall 60 of the channel 20, through the arcuate channel 56 adjacent the opening 58, through the opening 62 in the wall 64 of the channel 20 of an adjacent panel 10 and through the opening 66 in the flange 22 of the panel 10 into the channel 20 of the adjacent panel 10. A layer of roofing material 38 may then be applied to the panels 10 and secured with fasteners 40 as described hereinabove.

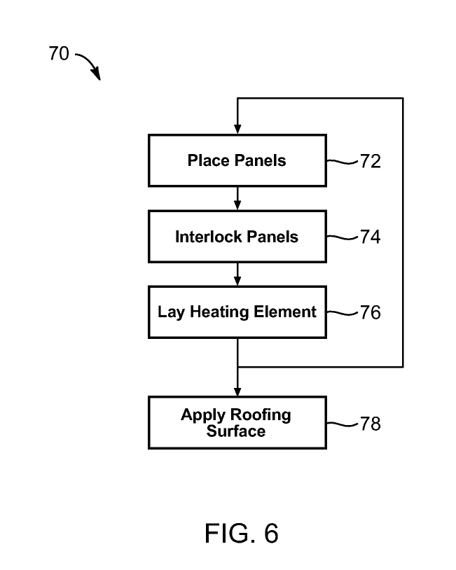

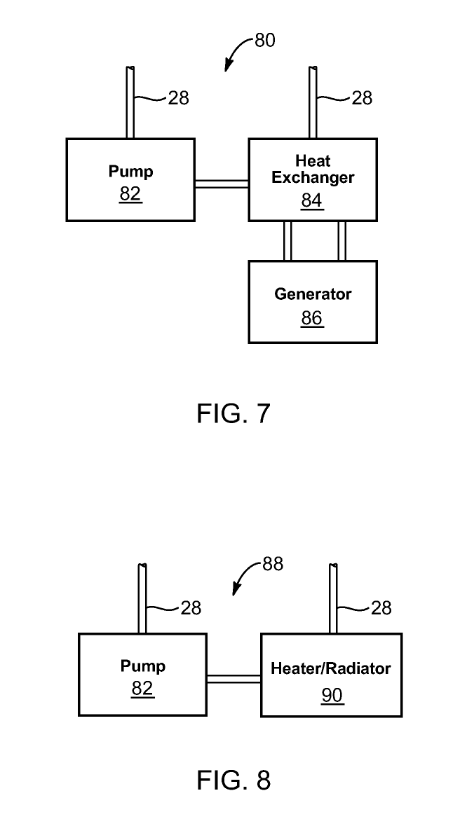

Referring to FIG. 6, a method 70 for using a panel according to the foregoing embodiments may include placing the panels 10 on a base layer 36 at step 72 and interlocking the panels at step 74. Steps 72 and 74 may include placing the panels 10 as described hereinabove having the first interlocking member 18a, such as the flange 22, positioned within the second interlocking 18b, such as the channel 20.

At step 76, the energy conducting element 28 is placed within the second interlocking member, such as the channel 20. In some embodiments, step 76 may be performed prior to step 76 for each panel, such as in the installation configuration of FIGS. 2A and 2B. Steps 72-76 may be performed repeatedly until a portion of the base layer 36 is covered.

A final, protective, weatherproof, roofing material 38 may then be applied at Step 78. Step 78 may also be performed while performing steps 72-76. Applying the roofing surface may include driving a fastener, such as a nail 40, screw, or other fastener, into the panels 10.

However, this also highlights the fact that the process 70 may follow installation of the roof structure of rafters, trusses, etc, and the base underlayment 36. The base underlayment installation may include, and typically does, dealing the base 36 with tarpaper, membrane, or the like as its top surface.

Referring to FIG. 7, as noted above, the energy conducting element 28 may be a tube, pipe, or conductive cable. In embodiments where the energy conducting element 28 is a conductive cable, current may be passed therethrough to generate heat along the length of the cable in order to melt snow of the roof or other structure. In embodiments where the energy conducting element 28 is embodied as a tube or pipe, heated fluid passing through the energy conducting element 28 may be handled by a fluid system 88.

The fluid system 88 may include a pump 82 operable to circulate fluid through the tube or pipe forming the energy conducting element 28. The pump 82 may also pump fluid from the energy conducting element 28 through a heat exchanger 84 in order to extract heat from the fluid.

For example, a roof or wall having the panels 10 and energy conducting element 28 mounted thereon may be heated by solar energy incident thereon, or on a roofing or siding material 38 placed thereover. Fluid with the energy conducting element 28 may then be circulated therein and heated thereby. This thermal energy may then be transferred from the fluid by the heat exchanger 84.

The heat exchanger 84 may extract the heat by transferring it to a second fluid. The second fluid may be undergoing a liquid to gas phase change. The expansion of the fluid undergoing the phase change may be used to drive a generator 86. In some embodiments, the heath exchanger 84 may use heat extracted from the fluid passing through the energy conducting element 28 to heat water or air for use within a structure of for some other purpose. In some embodiments, the fluid passing through the heating element 28 may be used as hot water by occupants of a structure without the use of an intermediate heat exchanger 84. In such embodiments, the pump 82 may pump all or part of the fluid to a hot water storage tank after passing the fluid through the energy conducting element 28.

Referring to FIG. 8, in some embodiments, the heat conducting element 28 is used to increase or decrease the temperature of the roof. In such embodiments, fluid passing through the energy conducting element 28 may be processed by the illustrated fluid handling system 88. In the system 88, the pump 82 may pump fluid through the heat conducting element 28 by way of a heater 90 or radiator 90 in order to heat or cool respectively, the fluid in order to control the temperature of the roof. For example, in the winter, a heater 90 may heat fluid pumped through the energy conducting element 28 in order to melt snow on the roof. In the summer, a radiator 90 may be used to cool fluid passing through the heating element 28 in order to reduce the temperature of the roof and the corresponding heating load on the cooling system of the structure.

The above description of embodiments of the invention is merely exemplary in nature and, thus, variations thereof are not to be regarded as a departure from the spirit and scope of the invention.

What is claimed and desired to be secured by United States Letters Patent is:

1. A method for installing a heat transfer system on a roof, the method comprising:
applying panels to the roof such that the panels have an interlocking relationship at interlocking interfaces between adjacent panels; and
laying an energy conducting element among the panels, the energy conducting element extending along the interlocking interfaces such that an upper surface of the energy conducting element does not protrude above the panels.

2. The method of claim 1, further comprising applying a roofing material over the panels and energy conducting element.

3. The method of claim 2, wherein the roofing material is at least one of asphalt shingles, metal panels, tar and gravel, shakes, clay tiles, and cement tiles and the panel is formed of a readily conducting heat transfer material.

4. The method of claim 1, wherein the panels each comprise:
first and second lateral sides;
a first interlocking member positioned along the first lateral side; and
a second interlocking member positioned along the second lateral side, the second interlocking member sized to receive the first interlocking member of an adjacent panel and a portion of the energy conducting element.

5. The method of claim 4, further comprising:
wherein applying panels to the roof comprises applying panels to a base layer positioned on the roof.

6. The method of claim 5, further comprising forming channels in the base layer, the channels sized to receive the second interlocking member;
wherein the second interlocking member and first interlocking member extend downwardly from a lower surface of the panels.

7. The method of claim 5, wherein the base layer comprises an insulating material.

8. The method of claim 7, wherein the insulating material is selected from a rigid foam and wood.

9. The method of claim 4, wherein the panels each define at least one arcuate channel extending between the first and second lateral sides; and
wherein laying the energy conducting element comprises laying the energy conducting element within both the second interlocking elements and arcuate channels of the panels

10. The method of claim 4, wherein the first interlocking member is a flange extending downwardly from a lower surface of each panel; and
wherein the second interlocking member is a channel formed on each panel and sized to receive the flange of an adjacent panel.

11. The apparatus of claim 1, wherein the panels comprise a heat conducting material.

12. The apparatus of claim 11, wherein the heat conducting material is a metal.

13. An apparatus for facilitating heat transfer on a roof comprising:
a plurality of panels secured to a roof such that the panels have an interlocking relationship at interlocking interfaces between adjacent panels; and
a energy conducting element positioned among the panels, the energy conducting element extending along the interlocking interfaces such that an upper surface of the energy conducting element does not protrude above the panels.

14. The apparatus of claim 13, further comprising a roofing material secured over the panels and energy conducting element.

15. The apparatus of claim 14, wherein the roofing material is at least one of asphalt shingles, metal panels, tar and gravel, shakes, clay tiles, and cement tiles.

16. The apparatus of claim 1, wherein the panels each comprise:
first and second lateral sides;
a first interlocking member positioned along the first lateral side; and
a second interlocking member positioned along the second lateral side, the second interlocking member sized to receive the first interlocking member of an adjacent panel and a portion of the energy conducting element.

17. The apparatus of claim 16, further comprising a base layer positioned between the roof and the panels, the base layer having channels formed therein and sized to receive the second interlocking member;
wherein the second interlocking member and first interlocking member extend downwardly from a lower surface of the panels into the channels

18. A panel for facilitating heat transfer on a roof comprising:
a planar portion having first and second lateral sides;
a first interlocking member positioned along the first lateral side;
a second interlocking member positioned along the second lateral side, the second interlocking member sized to receive the first interlocking member of an adjacent panel and a portion of the energy conducting element; and
at least one arcuate channel extending between the first and second lateral sides;
wherein the at least one arcuate channel and second interlocking member form a continuous path sized to receive a energy conducting element.

19. The apparatus of claim 18, wherein the at least one arcuate channel includes two arcuate channels having concave sides thereof facing one another.

20. The apparatus of claim 18,
wherein the first interlocking member is a flange extending downwardly from a lower surface of the planar portion;
wherein the second interlocking member is a channel extending downwardly from a lower surface of the planar portion and sized to receive the flange of an adjacent panel; and
wherein the flange and channel comprise openings sized and positioned to receive a energy conducting element extending through the at least one arcuate channel.
